(19) United States
(12) Patent Application Publication
(10) Pub. No.: US 2017/0316645 A1
(43) Pub. Date: Nov. 2, 2017

(54) GAMING MACHINE MANAGEMENT SYSTEM

(71) Applicant: PAOKAI ELECTRONIC ENTERPRISE CO., LTD., Kaohsiung (TW)

(72) Inventor: Ming-Shan Wei, Kaohsiung (TW)

(21) Appl. No.: 15/192,618

(22) Filed: Jun. 24, 2016

(30) Foreign Application Priority Data
Apr. 27, 2016 (TW) 105113180

(51) Int. Cl. G07F 17/32; A63F 9/30

(52) U.S. Cl. CPC G07F 17/3234; A63F 9/305; G07F 17/3206

(57) ABSTRACT

A gaming machine management system including a gaming machine, a host machine and a controller is disclosed. The gaming machine includes a control panel and a wireless communication module coupling with the control panel. The host machine is coupling with the wireless communication module. The controller is coupling with the host machine. The control panel transmits a state signal to the host machine via the wireless communication module. Moreover, the controller is able to read the state signal from the host machine of the gaming machine, and is able to transmit a control command to the gaming machine via the host machine. By such arrangement, the gaming machine management system can improve management efficiency and reduce maintenance expense of the gaming machine.

### CROSS REFERENCE TO RELATED APPLICATIONS

The application claims the benefit of Taiwan application Ser. No. 105113180, filed on Apr. 27, 2016, and the subject matter of which is incorporated herein by reference.

### BACKGROUND OF THE INVENTION

### 1. Field of the Invention

The present invention generally relates to a gaming machine management system and, more particularly, to a gaming machine management system having a wireless communication module.

### 2. Description of the Related Art

Gaming machines, such as claw vending type machines, hitting type machines, or ball game type machines, have been being popular and favored in amusement arcade for a long time, because these gaming machines are easy to operate and able to provide interactive experience.

Besides the cost of space, the cost of gaming machine maintenance always takes a significant percentage in the necessary expense of an operator for running an amusement arcade. The reason is that, there is usually a huge amount of gaming machines installed in the amusement arcade, and each of the gaming machines relies on manual and individual inspection for parameter adjustment, troubleshooting, or consumable supplying (such as, the objects to be gripped). Thus, the operator has to spend a high personnel expense to maintain all of the gaming machines. Moreover, in order to check whether the maintenance of each of the gaming machines has been done thoroughly by the employee, the operator needs to hire additional personnel to check each of the gaming machines or has to do it in person. Thus, the personnel or the time expense is further increased.

In light of the above, the present disclosure provides a gaming machine management system to overcome the problem of high personnel or time expense and low management efficiency of current gaming machine maintenance.

### SUMMARY OF THE INVENTION

It is therefore the objective of this invention to provide a gaming machine management system having a wireless communication module.

In an embodiment of the present disclosure, the gaming machine management system includes a gaming machine having a control panel and a wireless communication module coupling with the control panel, a host machine coupling with the wireless communication module, and a controller coupling with the host machine. The control panel transmits a state signal to the host machine via the wireless communication module. Moreover, the controller is able to read the state signal from the host machine of the gaming machine, and is able to transmit a control command to the gaming machine via the host machine.

One or more of the following features may be included. The control panel may include an operation parameter, and the control panel may transmit the operation parameter to the host machine as the state signal. The control command transmitted by the controller may include an adjustment instruction of the operation parameter.

The operation parameter may include a price or a gameplay setting of the gaming machine.

The gaming machine may include a claw coupling with the control panel. The operation parameter may include a strength or a hit rate of the claw.

The control panel may be combined with a coin box, and the control panel may count an amount of coins received by the coin box and may transmit the amount of coins to the host machine as the state signal.

If the coin box has not been receiving any coin in a predetermined period of time, the control panel may generate and may transmit an alert message to the host machine as the state signal.

The gaming machine may include a surveillance camera facing toward a cabinet adapted for receiving objects to be gripped, and the surveillance camera may couple with the wireless communication module.

The gaming machine may include a portrait camera coupling with the control panel.

The gaming machine may include a display panel coupling with the control panel. After the portrait camera transmits a photo to the host machine, the display panel may show a hyperlink to the photo.

The gaming machine may include a plurality of lighting bars coupling with the control panel.

The portrait camera may include a flashlight.

According to the gaming machine management system in the embodiment above, adjustment of the operation parameter of the gaming machine, noticing of abnormal operation status of the gaming machine and monitoring of storage of consumables of the gaming machine, can all be conducted via the controller. Thus, management efficiency of the gaming machine can be significantly increased, and a function of reducing maintenance expense of the gaming machine is provided.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a block diagram of a system structure of a gaming machine of the present disclosure.

FIG. 2 shows an exterior appearance of the gaming machine in an embodiment of the present disclosure.

FIG. 3 is a block diagram of the system structure of the gaming machine having a display panel of the present disclosure.

### DETAILED DESCRIPTION OF THE INVENTION

“Couple with” in the present disclosure means that data can be sent to each other between two devices via a communication interface, and is well understood by a person having ordinary skill in the art of the present disclosure.

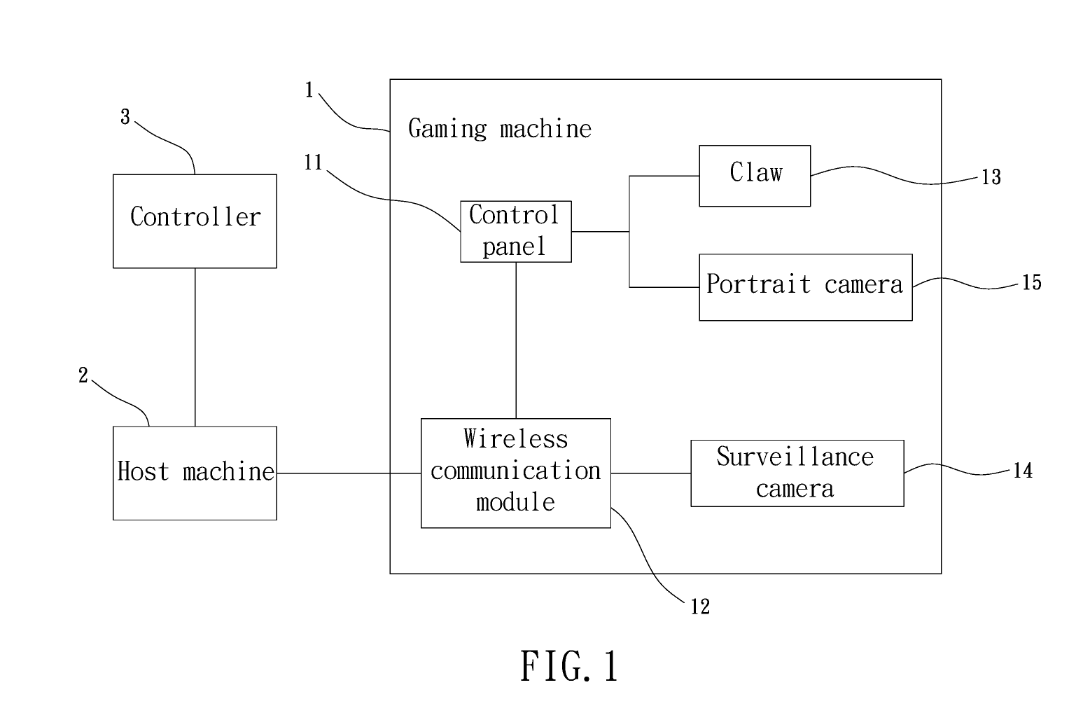

With reference to FIG. 1, a gaming machine management system of an embodiment of the present disclosure comprises a gaming machine 1, a host machine 2 and a controller 3. The host machine 2 couples with the gaming machine 1 and the controller 3, respectively.

The gaming machine 1 comprises a control panel 11 and a wireless communication module 12 coupling with each other. The control panel 11 controls operation of each component of the gaming machine 1. The wireless communication module 12 may comprise a wireless transmission interface such as Wi-Fi, Infrared ray, Bluetooth, Zigbee or Global System for Mobile (“GSM”). The wireless communication module 12 couples with the host machine 2.

The host machine 2 may comprise a mainframe computer, a workstation, a fileserver or a cloud storage space. Because the host machine 2 couples with the wireless communication module 12, and the wireless communication module 12 couples with the control panel 11, the control panel 11 is able to send a state signal to the host machine 2 via the wireless communication module 12.

The controller 3 may be a control device with input/output function, such as a remote control, a control panel, a personal computer, a cell phone, a tablet or a laptop. The controller 3 can couple with the host machine 2 via wire or wireless transmission. Accordingly, the controller 3 is able to read the state signal sent from the gaming machine 1 via the host machine 2, and the controller 3 is also able to transmit a control command to the gaming machine 1 via the host machine 2.

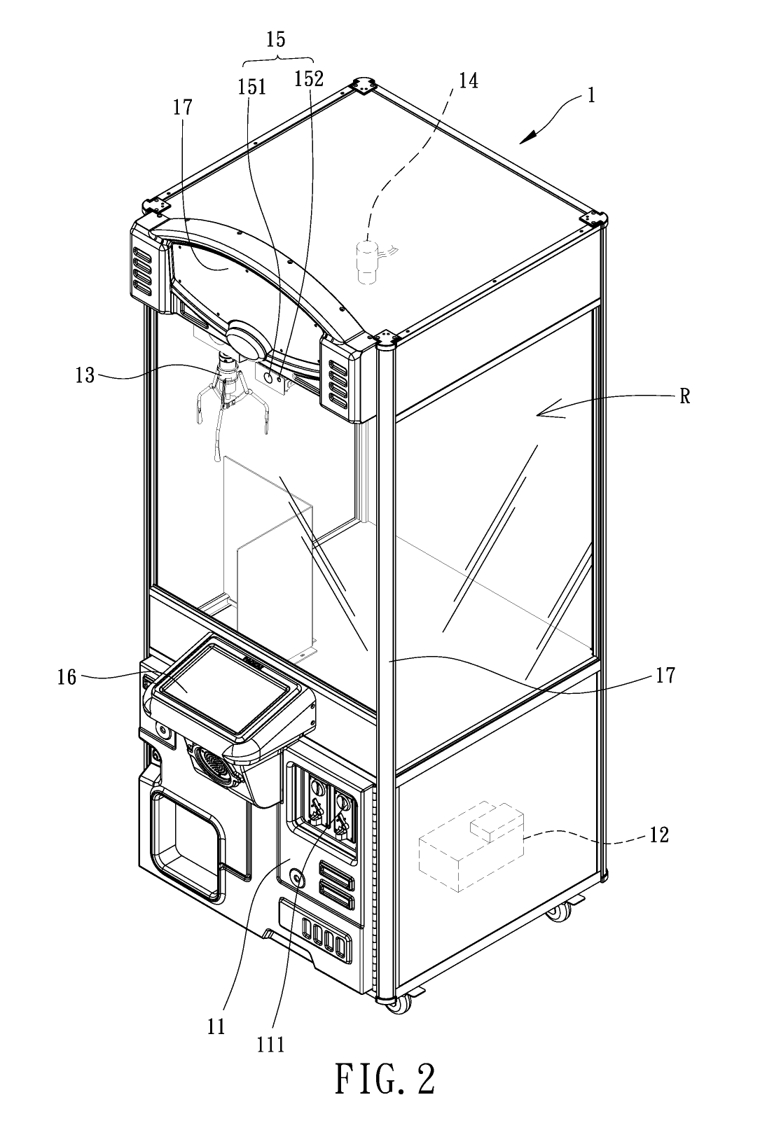

According to the structure mentioned above, the gaming machine management system in the embodiment of the present disclosure can couple with a plurality of gaming machines 1 simultaneously when in actual operation. With reference to FIG. 2, an embodiment of the gaming machine 1 is disclosed. In the embodiment, the gaming machine 1 can be a claw vending type machine. The control panel 11 can control the operation of each component of the gaming machine 1. Thus, the control panel 1 comprises an operation parameter, and the operation parameter may comprise a “price” or a “gameplay setting” of the gaming machine 1. More specifically, the control panel 11 may usually be combined with a coin box 111. When the coin box 111 receives a predetermined amount of coin(s) (such as 1 coin), the control panel 11 starts the gaming machine 1. The predetermined amount of coins is the “price” of the gaming machine 1. On the other hand, when the coin box 111 receives the predetermined amount of coins, the control panel 11 starts the gaming machine for one time (one for a coin) or for several times (two for a coin) for the consumer to play. Moreover, after the coin box 111 receives a target amount of coins (such as 10 coins), the control panel 11 can give the consumer one or more free plays, or start special modes such as guaranteed prize mode. Such setting is the “gameplay setting” of the gaming machine 1.

The control panel 11 can transmit the operation parameter of the “price” or the “gameplay setting” of the gaming machine 1 to the host machine 2 as the state signal. Accordingly, the manager is able to read the operation parameter of the control panel 11 via the host machine 2 with the controller 3, to know the operation parameter of current setting of the gaming machine 1. Furthermore, when adjusting the operation parameter, the manager only needs to operate the controller 3 to transmit a control command to the gaming machine 1 via the host machine 2, and the control command may comprise the adjustment instruction of the operation parameter. Thus, the control panel 11 can receive the control command from the wireless communication module 12 and adjust the operation parameter accordingly.

From the above, comparing to conventional gaming machines of which the adjustments of operation parameters of the “price” or the “gameplay setting” need to be conducted manually and individually, the gaming machine management system in the embodiment of the disclosure enables the manager to directly transmit control command to the gaming machine 1 via the controller 3 in order to adjust the operation parameter of one or more gaming machines 1. Moreover, the manager can also read the operation parameters of each of the gaming machines 1 from the host machine 2 via the controller 3, to control the overall operation status of the one or more gaming machines 1. Thus, the management efficiency of the gaming machine 1 can be significantly increased, and a function of reducing the maintenance expense of the gaming machine is provided by the gaming machine management system in the embodiment of the disclosure.

More practically, because the adjustments of operation parameters of the “price” or the “gameplay setting” of conventional gaming machines need to be conducted manually and individually, a huge amount of personnel or time expense is required to complete the operation parameter adjustment of each of the gaming machines when the amount of the gaming machines is big. Therefore, practically, the manager usually tends to fix the operation parameters of the “price” or the “gameplay setting” of each of the gaming machines. However, the gaming machine management system in the embodiment of the disclosure enables the manager to adjust the operation parameters of each of the gaming machines 1 via the controller 3 rapidly, in order to have the operation parameters adjusted immediately according to conditions such as the number of the consumers. For example, the manager can raise the “price” of each of the gaming machines or change the “gameplay setting” from “two for a coin” to “one for a coin” during popular periods (periods having more consumers) on weekends or holidays, and adjust the parameters back to usual values after the popular periods have passed, to maximize the profit of the amusement arcade.

Furthermore, even if the conventional gaming machines have been manually and individually adjusted, the operator is still not able to check the operation parameters of each of the gaming machines after adjustments. In other words, the operator needs to hire additional personnel to check each of the gaming machines or has to do it in person to confirm whether the operation parameters of each of the gaming machines have been set to the desired value. In contrast, the gaming machine management system in the embodiment of the disclosure enables the manager to read the operation parameters of each of the gaming machines 1 from the host machine 2 via the controller 3, in order to rapidly control the operation parameters before and after adjustments of each of the gaming machines 1.

Thus, the management efficiency of the gaming machines is significantly increased, and the personnel expense and time expense are significantly reduced.

Moreover, the control panel 11 can record the operation status of the gaming machine 1. For example, the control panel 11 can count the amount of coins received by the coin box 111, and transmit the counted amount as the state signal to the host machine 2. Accordingly, the manager can know individual operation statuses of each of the gaming machines 1 via the controller 3 as references of adjustments of operation parameters of each of the gaming machines 1 or updates (such as replacing objects to be gripped) or substitution of each of the gaming machines 1. Alternatively, if the coin box 111 has not been receiving any coin in a predetermined period of time (such as 4 hours), the control panel 11 can generate an alert message as the state signal and transmit the state signal to the host machine 2. Accordingly, the manager can notice the abnormal operation status of the gaming machine 1 via the controller 3, and immediately send personnel to check whether the gaming machine 1 is malfunctioned, to increase the troubleshooting speed of the gaming machine 1. In contrast, if the conventional gaming machine has abnormal operation status caused by factors such as malfunction, it may only be discovered and fixed during routine inspection, unless being reported by a consumer. Thus, the operator usually suffers avoidable losses.

In this embodiment, the gaming machine is a claw vending type machine, and comprises a claw 13 coupling with the control panel 11. The operation parameter may not only comprise the “price” or the “gameplay setting” of the gaming machine 1, but also comprise a “strength” or a “hit rate” of the claw 13. More specifically, a power output to the claw 13 from the control panel 11 affects the “strength” of claw 13 gripping the objects. The control panel 11 may also control ratios of the claw 13 gripping the objects firmly and merely touching the objects. For example, the control panel may control the claw 13 to have 30% chance gripping the objects firmly, while the other 70% chance merely touching the objects. The 30% chance here is the “hit rate” of the claw 13. The operation parameters such as the “strength” or the “hit rate” may directly affect the difficulty for the consumer operating the gaming machine 1 to grip the object.

The gaming machine management system in the embodiment of the disclosure may similarly enable the manager to transmit the control command to the control panel 11 via the controller 3 and to adjust the operation parameters of the “strength” and the “hit rate” of the claw 13 accordingly. Thus, the manager can immediately adjust the difficulty of each of the gaming machines 1 according to the number of the consumers or the individual operation status of each of the gaming machines 1, to balance the gaming experience of the consumers and the profit of the amusement arcade.

Though the gaming machine 1 is a claw vending type machine in the above mentioned embodiment, the gaming machine 1 may also be a hitting type machine (such as a whack-a-mole machine), or a ball game type machine (such as a basketball machine). When the gaming machine 1 is the hitting type machine, the operation parameter may comprise the “extending speed” of objects to be hit. Similarly, when the gaming machine 1 is the basketball machine, the operation parameter may comprise the “moving speed” of the rim. The operation parameter of the “extending speed” or the “moving speed” directly affects the difficulty for the consumers to operate the gaming machine 1. Accordingly, when the host machine 2 couples with a plurality of gaming machines 1 of different types, the gaming machine management system in the embodiment of the disclosure may still enable the manager to immediately adjust the “price”, the “gameplay setting” or the difficulty of each of the gaming machines 1 via the controller 3. Thus, the gaming machine management system can be adopted for different types of the gaming machines 1, and is not limited to the claw vending type machine mentioned in the embodiment above.

On the other hand, the gaming machine 1 may comprise a surveillance camera 14 facing toward a cabinet R. The cabinet R is adapted for receiving the objects to be gripped (such as dolls). The surveillance camera 14 couples with the wireless communication module 12. The surveillance camera 14 can monitor the cabinet R to generate an image, and send the image to the host machine 2 to enable the manager to read the image from the host machine 2 via the controller 3. Accordingly, the manager can check storage of the objects to be gripped received in the cabinet R from the image, and send personnel to refill or replace the objects to be gripped when the storage is low. The manager can further confirm whether the objects to be gripped have been refilled or replaced from the image, to prevent the consumers from being unwilling to play due to low storage of the objects to be gripped, which harms the profit of the gaming machine 1. On the contrary, the conventional claw vending type machines rely on inspection of the manager or other personnel to monitor the storage of the objects to be gripped. Even if the personnel have been instructed to refill or replace the objects to be gripped, the manager still has to inspect the gaming machines 1 in person for confirmation. By installing the surveillance camera 14 on the gaming machine 1, the gaming machine management system in the embodiment of the disclosure enables the manager to monitor the storage of the objects to be gripped, in order to increase the management efficiency of the objects to be gripped.

Furthermore, as described above, the control panel 11 can count the amount of coins received by the coin box 111, and can enable the manager to know the operation status of the gaming machine 1 via the controller 3. Moreover, the manager can also monitor the storage of the objects to be gripped via the controller 3. Thus, the manager can determine whether the operation parameters such as the “strength” or the “hit rate” of the claw 13 are appropriate based on the operation status and change of the storage of the objects to be gripped of the gaming machine 1, and adjust the difficulty obtaining the object from the gaming machine 1 accordingly, in order to balance the gaming experience of the consumers and the profit of the gaming machine 1.

In addition, the gaming machine 1 may comprise a portrait camera 15 coupling with the control panel 11. Thus, when the control panel 11 senses that the consumer successfully obtains the object to be gripped or breaks the highest score, the portrait camera 15 can take a photo of the consumer and send the photo to the host machine 2. The host machine 2 can be connected to the internet to allow the consumer to download the photo or to share the photo to social media to present the object or the highest score. Thus, the feeling of freshness and the sense of accomplishment of the consumer can be enhanced when operating the gaming machine 1.

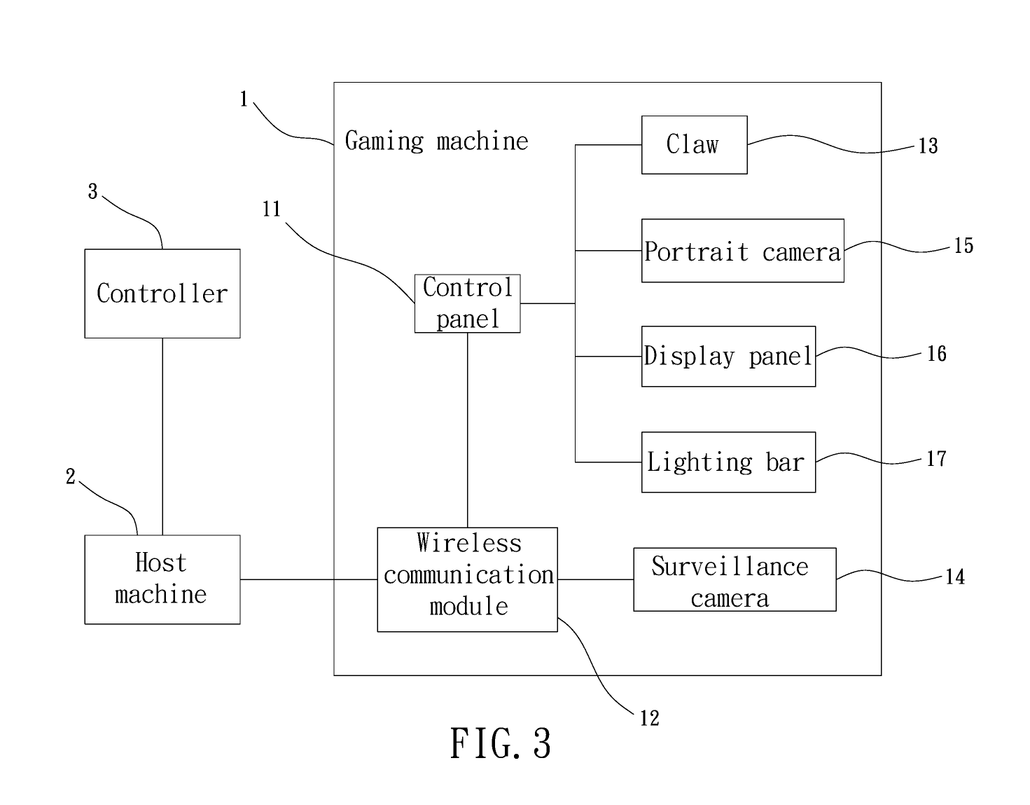

More specifically, with reference to both FIGS. 2 and 3, in some of the embodiments of the present disclosure, the gaming machine 1 may comprise a display panel 16 coupling with the control panel 11. Accordingly, when the control panel 11 controls the portrait camera 15 to take photo of the consumer, the display panel 16 can display a message to direct the consumer to look at the portrait camera 15. Moreover, after the portrait camera 15 sends the photo to the host machine 2, the display panel 16 can show a hyperlink to the photo. The hyperlink may appear as a website address, or be processed as a QR code for the consumer to scan. Thus, the consumer can complete the photo shot and link to the host machine 2 to obtain the photo according to the instructions of the display panel 16.

The gaming machine 1 generally comprises a plurality of lighting bars 17. The lighting bar 17 can generate different colors of lighting frames to attract the consumers with colorful visual effects. It is noted that, considering some amusement arcades may adopt dim lighting for making certain atmosphere, the portrait camera 15 may have difficulty taking clear photos with such dim lighting. Thus, the control panel 11 can be coupled with each of the plurality of lighting bars 17. Accordingly, when the control panel 11 controls the portrait camera 15 to take photo of the consumer, the control panel 11 may also control the plurality of lighting bars 17 to emit white light or other colors of light with higher brightness, to ensure that the portrait camera 15 can take a clear photo.

Alternatively, with reference to FIG. 2, the portrait camera 15 may comprise a lens 151. The lens 151 is able to receive light when the portrait camera 15 is taking the photo, to help the image to form. The gaming machine 1 in some embodiments of the present disclosure may also comprise a flashlight 152. The flashlight 152 can generate a flash when the portrait camera 15 is taking the photo, to ensure that the portrait camera 15 is able to take a clear photo with dim lighting.

According to the above, the gaming machine management system in the embodiments of the present disclosure comprises a wireless communication module 12 in a gaming machine 1. A host machine 2 couples with the wireless communication module 12, to enable a controller 3 to read a state signal output by the gaming machine 1 via the host machine 2. The controller 3 can also transmit a control command to the gaming machine 1 via the host machine 2. The state signal may comprise operation parameters of a “price”, a “gameplay setting”, or a difficulty of the gaming machine 1. Thus, the controller 3 can complete adjustments of the operation parameters of one or more gaming machines 1 by directly transmits the control command to the one or more gaming machines 1. Thus, the manager can also read the operation parameters of each of the gaming machines 1 from the host machine 2 via the controller 3, to control overall operation status of the gaming machines 1.

Furthermore, a control panel 11 of the gaming machine 1 can count an amount of coins received by a coin box 111, and transmit the amount of coins to the host machine 2 as the state signal. If the coin box 111 has not been receiving any coin in a predetermined period of time, the control panel 11 can generate and transmit an alert message to the host machine 2 as the state signal. Thus, the manager can notice the abnormal operation status of the gaming machine 1 via the controller 3, and can immediately send personnel to inspect whether the gaming machine 1 malfunctioned. As a result, the troubleshooting speed of the gaming machine 1 is significantly increased.

Moreover, the gaming machine 1 may comprise a surveillance camera 14 facing toward a cabinet R adapted for receiving objects to be gripped. The surveillance camera 14 monitors the cabinet R to generate an image, and sends the image to the host machine 2. The manager can check a storage of the objects to be gripped received in the cabinet R from the image, and can immediately send personnel to refill or replace the objects to be gripped when the storage is low.

Accordingly, comparing to conventional gaming machines which rely on manual and individual inspections on no matter parameter adjustment, troubleshooting or consumable supplying, the gaming machine management system in the embodiments of present disclosure can complete the adjustments of the operation parameters of the gaming machine 1, notice the abnormal operation status of the gaming machine 1 and monitor the storage of the consumables of the gaming machine 1, via the controller 3. Thus, the management efficiency of the gaming machine 1 can be significantly increased, and a function of reducing maintenance expense of the gaming machine 1 is provided.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A gaming machine management system, comprising:
a gaming machine comprising a control panel and a wireless communication module coupling with the control panel;
a host machine coupling with the wireless communication module; and
a controller coupling with the host machine;
wherein the control panel transmits a state signal to the host machine via the wireless communication module, wherein the controller is able to read the state signal from the host machine of the gaming machine, and is able to transmit a control command to the gaming machine via the host machine.

2. The gaming machine management system as claimed in claim 1, wherein the control panel comprises an operation parameter, and the control panel transmits the operation parameter to the host machine as the state signal, and wherein the control command transmitted by the controller comprises an adjustment instruction of the operation parameter.

3. The gaming machine management system as claimed in claim 2, wherein the operation parameter comprises a price or a gameplay setting of the gaming machine.

4. The gaming machine management system as claimed in claim 2, wherein the gaming machine comprises a claw coupling with the control panel, and wherein the operation parameter comprises a strength or a hit rate of the claw.

5. The gaming machine management system as claimed in claim 1, wherein the control panel is combined with a coin box, and the control panel counts an amount of coins received by the coin box and transmits the amount of coins to the host machine as the state signal.

6. The gaming machine management system as claimed in claim 5, wherein if the coin box has not been receiving any coin in a predetermined period of time, the control panel generates and transmits an alert message to the host machine as the state signal.

7. The gaming machine management system as claimed in claim 1, wherein the gaming machine comprises a surveillance camera facing toward a cabinet adapted for receiving objects to be gripped, and wherein the surveillance camera couples with the wireless communication module.

8. The gaming machine management system as claimed in claim 1, wherein the gaming machine comprises a portrait camera coupling with the control panel.

9. The gaming machine management system as claimed in claim 8, wherein the gaming machine comprises a display panel coupling with the control panel, wherein after the portrait camera transmits a photo to the host machine, the display panel shows a hyperlink to the photo.

10. The gaming machine management system as claimed in claim 8, wherein the gaming machine comprises a plurality of lighting bars coupling with the control panel.

11. The gaming machine management system as claimed in claim 8, wherein the portrait camera comprises a flashlight.
